(19) United States
(12) Patent Application Publication
(10) Pub. No.: US 2012/0144288 A1
(43) Pub. Date: Jun. 7, 2012

(54) WEB PAGE CONTENT DISPLAY PRIORITY AND BANDWIDTH MANAGEMENT

(75) Inventors: Vincenzo Caruso, Grimaldi (CS) (IT); Javier Rodriquez, Dublin (IE); Carol S. Zimmet, Boxborough, MA (US)

(73) Assignee: INTERNATIONAL BUSINESS MACHINES CORPORATION, Armonk, NY (US)

(21) Appl. No.: 12/959,360

(22) Filed: Dec. 2, 2010

(51) Int. Cl. G06F 3/048

(52) U.S. Cl. 715/234

(57) ABSTRACT

The method generates web page attributes information that a web content manager uses to determine relative priority for each web page element of the web page. The method determines those web page elements residing within or outside of a web page viewable area. The method provides for user input into web page element prioritization by type and further provides for modification to web page attribute information. The web content manager generates prioritization of each web page element from categories of input for web page content rendering prioritization. The categories of input may include resource attributes, context attributes, user preferences, and prioritization rules. The method may normalize web page element prioritization information and determines bandwidth allocation for each web page element. The method retrieves and renders each visible web page element consistent with the bandwidth allocation for each web page element during display.

### BACKGROUND

The disclosures herein relate generally to information handling systems (IHSs), and more specifically, to management of World Wide Web (WWW) content display resources in an IHS.

Information handling systems (IHSs) include operating systems that execute useful World Wide Web (WWW) page display resources, such as browser and Internet information access related applications. Users may load and execute web browser applications within an IHS to access web pages from other IHS sources, such as nodes, servers, or other web resources on the Internet. The Internet is a global system of IHS resources and networks that communicate using standardized interconnect protocols, such as transmission control protocol/Internet protocol (TCP/IP). The WWW is a system of information including hypertext documents that IHS resources may access using Internet protocols and web browser applications. Web browsers may provide access to WWW content in the form of multiple web page elements. Web page elements may include video, text, images, and other multimedia content.

A user's experience during web page content access may be highly dependent upon the success of rendering web page elements quickly and efficiently. Users are rightfully impatient with web pages that render slowly. Management of web page communication bandwidth plays a key role in successful web page display.

### BRIEF SUMMARY

In one embodiment, a method of managing web content is disclosed. The method includes receiving, by a web content manager, user web page preference information including web page attributes that include web page element attributes, each web page element attribute exhibiting a respective initial display priority. The method also includes receiving, by the web content manager, context attributes information that specifies characteristics of a particular display environment. The method further includes receiving, by the web content manager, a particular web page of information from a web source, the particular web page including particular web page elements. The method still further includes determining, by the web content manager, web page resource attributes corresponding to the particular web page. The method also includes determining, by the web content manager, an initial display priority for each of the particular web page elements. The method further includes determining, by the web content manager, a modified display priority for each of the particular web page elements by applying at least one of user preferences information and context attributes information to the particular web page elements. The method also includes assigning, by the web content manager, a bandwidth allocation for each particular web page element based on the modified display priority for each of the particular web page elements. The method further includes displaying, by the web content manager, each particular web page element based on the modified display priority for each particular web page element.

In another embodiment, an information handling system (IHS) is disclosed that includes a processor. The IHS also includes a memory coupled to the processor. The memory includes a web content manager that is configured to receive user web page preference information including web page attributes that include web page element attributes, each web page element attribute exhibiting a respective initial display priority. The web content manager is also configured to receive context attributes information that specifies characteristics of a particular display environment. The web content manager is further configured to receive a particular web page of information from a web source, the particular web page including particular web page elements. The web content manager is still further configured to determine web page resource attributes corresponding to the particular web page. The web content manager is also configured to determine an initial display priority for each of the particular web page elements. The web content manager is further configured to determine a modified display priority for each of the particular web page elements by applying at least one of user preferences information and context attributes information to the particular web page elements. The web content manager is also configured to assign a bandwidth allocation for each particular web page element based on the modified display priority for each of the particular web page elements. The web content manager is further configured to display each particular web page element based on the modified display priority for each particular web page element.

In yet another embodiment, a web content manager computer program product is disclosed that includes a computer readable storage medium for use on an information handling system (IHS). The computer program product includes first instructions that receive user web page preference information including web page attributes that include web page element attributes, each web page element attribute exhibiting a respective initial display priority. The computer program product also includes second instructions that receive context attributes information that specifies characteristics of a particular display environment. The computer program product further includes third instructions that receive a particular web page of information from a web source, the particular web page including particular web page elements. The computer program product still further includes fourth instructions that determine web page resource attributes corresponding to the particular web page. The computer program product also includes fifth instructions that determine an initial display priority for each of the particular web page elements. The computer program product further includes sixth instructions that determine a modified display priority for each of the particular web page elements by applying at least one of user preferences information and context attributes information to the particular web page elements. The computer program product also includes seventh instructions that assign a bandwidth allocation for each particular web page element based on the modified display priority for each of the particular web page elements. The computer program product further includes eighth instructions that display each particular web page element based on the modified display priority for each particular web page element. The first, second, third, fourth, fifth, sixth, seventh and eighth instructions are stored on the computer readable storage medium.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a representative information handling system (IHS) that employs the disclosed web content manager methodology.

FIG. 2 is a block diagram of web page content that includes multiple web page elements that the disclosed web content manager methodology may employ.

FIG. 3 is a diagram of web page attributes that the disclosed web content manager methodology may employ.

FIG. 4 is a flowchart of one embodiment of the disclosed web content manager methodology that manages web page content retrieval and display.

### DETAILED DESCRIPTION

Information handling systems (IHSs) typically employ operating systems that may execute web browser applications or web browsers. Web browsers provide useful resources for users that enable convenient information retrieval from the World Wide Web (WWW). Web browsers access, load, or otherwise retrieve web page content from other resources of the Internet, such as remote servers, web sources, web servers, as well as other sources. Web browsers may present, display, or otherwise render WWW information or content in the form of web pages or web page content on displays or other resources within a receiving IHS. Although web browsers primarily access the WWW, users may also use web browsers to access information within local servers, private networks, or file systems local to the retrieving IHS.

Web browsers access web page content, or web pages that include information in the form of HyperText Markup Language (HTML), Extensible HyperText Markup Language (XHTML), or other language formats. Web pages may include multiple web page elements, such as video, text, image, and other elements. Web page elements may include streaming video, hypertext links, and images in multiple presentation formats. For example, web page elements may include static images such as Graphics Interchange Format (GIF), Joint Photographic Experts Group (JPEG), and other static images. Web page elements may include animated or moving images such as animated GIF, animated Scalable Vector Graphics (SVG), Adobe Flash, Java Applets or other animated images.

Web page elements may further include audio or audio links to Musical Instrument Digital Interface (MIDI), Waveform Audio File Format (WAV) or other audio sources. Web page elements may also include video in the form of Windows Media Video (WMV), Moving Pictures Experts Group (MPEG), or other video source format content. Web page elements may include interactive information such as Dynamic HTML (DHTML), Adobe Flash, Java applets, or other interactive content. Web page elements may include hyperlinks, forms, scripts, and other links to WWW information. Web pages include other elements and other content to provide a user with access to WWW information in an efficient and useful manner. However, as web page information increases, display resources typically inhibit viewing of all web page information in the viewable area or viewport at any particular point in time. This is particularly evident in smaller handheld display devices.

Web pages may often require more display or viewable screen space than is available for a particular display resolution. In that case, web browsers may provide scroll bars or other web page scrolling features to enable user input that controls web page display positioning. A user may scroll up, scroll down, scroll left, or scroll right to view web page content that is out of view, or in the non-viewable region of the current display or viewport. In one embodiment of the disclosed web content manager, during retrieval of web page content, the web browser may interpret web page content that is outside the viewable display as less important and therefore of less priority to the user. The web browser may further limit the amount of IHS resources, such as communication bandwidth for those web page elements that are outside the viewable display. Current web browsers may retrieve and render all elements of a web page with equal priority. In other words, retrieving and rendering a video image at the lower right side of a web page may receive the same priority as retrieving and rendering a still picture at the upper left side of the web page.

As described in more detail below, the disclosed web browser software may provide an improved user experience by managing the priority and communication bandwidth for particular or individual elements of a web page. For example, a greater importance and use of IHS resources may apply to those web page elements in the viewable region of the display. Web browsers may also apply a greater importance to web page elements that are in proximity to a user point of interest, such as those web page elements in proximity to a mouse pointer or other pointing or tracking device. In the disclosed web browser methodology, the prioritization of particular web page elements may relate to the bandwidth that the receiving IHS applies to these particular web page elements during their retrieval and rendering on display resources of the IHS. The user web page retrieval experience may be improved by providing user access and selection of web page element prioritization via user selected web page attribute information, as described in more detail below.

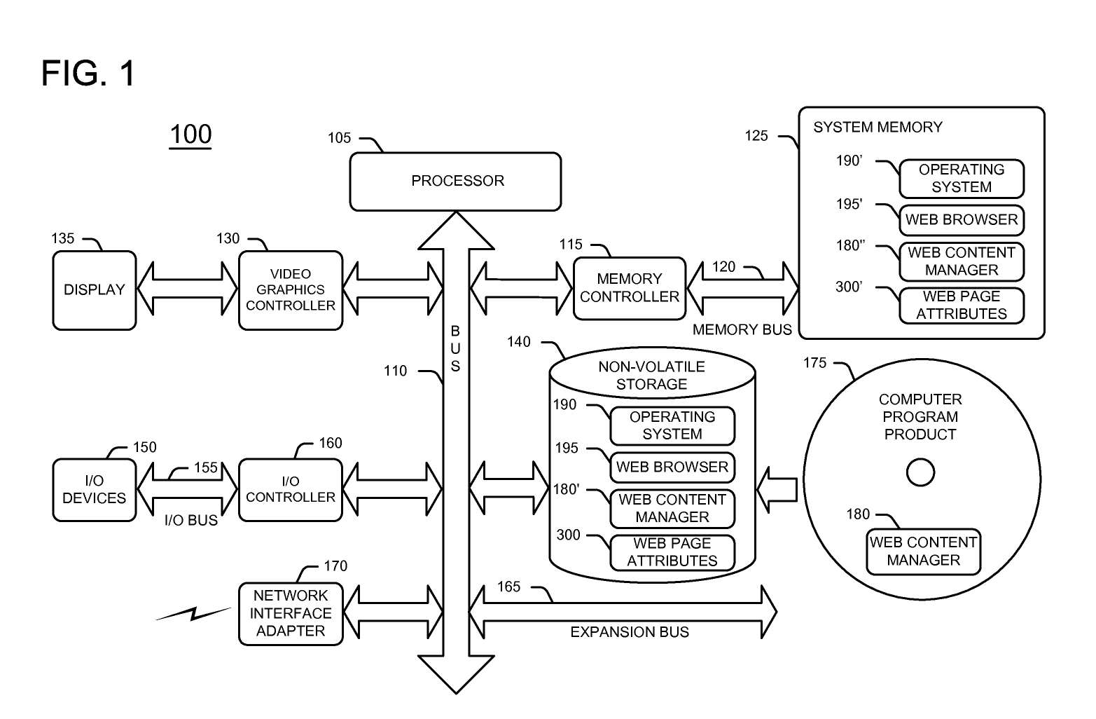

FIG. 1 shows an information handling system 100 including a web content manager application 180 and a web page attributes information store 300 that practices the disclosed web content manager methodology. IHS 100 includes a processor 105 that may include multiple cores. IHS 100 processes, transfers, communicates, modifies, stores or otherwise handles information in digital form, analog form or other form. IHS 100 includes a bus 110 that couples processor 105 to system memory 125 via a memory controller 115 and memory bus 120. In one embodiment, system memory 125 is external to processor 105. System memory 125 may be a static random access memory (SRAM) array or a dynamic random access memory (DRAM) array. Processor 105 may also include local memory (not shown) such as L1 and L2 caches (not shown). A video graphics controller 130 couples display 135 to bus 110. Nonvolatile storage 140, such as a hard disk drive, CD drive, DVD drive, or other nonvolatile storage couples to bus 110 to provide IHS 100 with permanent storage of information. I/O devices 150, such as a keyboard and a mouse pointing device, couple to bus 110 via I/O controller 160 and I/O bus 155.

One or more expansion busses 165, such as USB, IEEE 1394 bus, ATA, SATA, PCI, PCIE, DVI, HDMI and other busses, couple to bus 110 to facilitate the connection of peripherals and devices to IHS 100. A network interface adapter 170 couples to bus 110 to enable IHS 100 to connect by wire or wirelessly to a network and other information handling systems. In this embodiment, network interface adapter 170 may also be called a network communication adapter or a network adapter. While FIG. 1 shows one IHS that employs processor 105, the IHS may take many forms. For example, IHS 100 may take the form of a desktop, server, portable, laptop, notebook, netbook, tablet or other form factor computer or data processing system. IHS 100 may take other form factors such as a gaming device, a personal digital assistant (PDA), a portable telephone device, a communication device or other devices that include a processor and memory.

IHS 100 includes an operating system (OS) 190 that nonvolatile storage 145 stores. IHS 100 also includes a web browser 195 that nonvolatile storage 145 stores. IHS 100 includes a computer program product on digital media 175 such as a CD, DVD or other media. In one embodiment, a designer or other entity configures the computer program product with web content manager application 180 to practice the disclosed web content manager methodology. During operation of IHS 100, web content manager 180 may generate and otherwise manage a web page attributes information store 300 in nonvolatile storage 300. In one embodiment of the disclosed web content manager methodology, web browser 195 includes web content manager 180 capability integrated with web page retrieval and display capability. In other words, web content manager 180 provide a capability on top of or integrated into web browser 195.

Web content manager 180 may generate web page attributes 300 from default settings that web content manager 180 employs. During normal operation of IHS 100, web content manager 180 may further update or modify web page attributes 300 consistent with the teachings of the disclosed web content manager methodology. In practice, IHS 100 may store web content manager 180 on nonvolatile storage 145 as web content manager 180′. When IHS 100 initializes, the IHS may load web content manager 180′, web page attributes 300, OS 190 and web browser 195 into system memory 125 for execution as web content manager 180″, web page attributes 300′, OS 190′, and web browser 195′, respectively.

As will be appreciated by one skilled in the art, aspects of the disclosed web content manager methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product, such as computer program product 175 embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

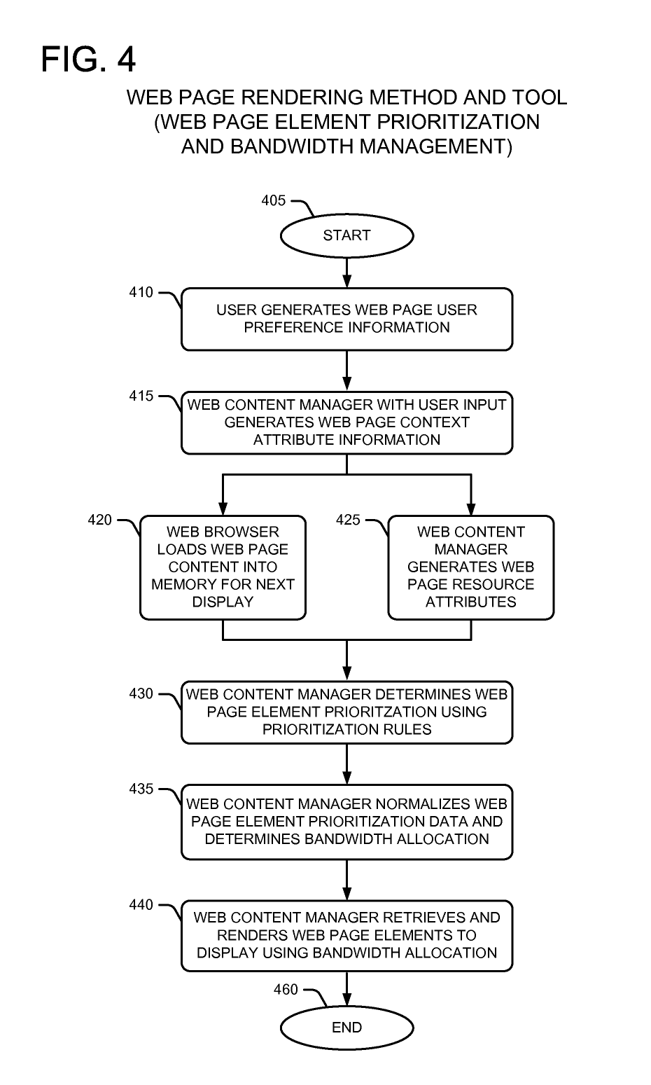

Aspects of the present invention are described below with reference to flowchart illustrations and/or block diagrams of methods, apparatus (systems) and computer program products according to embodiments of the invention. It will be understood that each block of the FIG. 4 flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts of FIG. 4 and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart of FIG. 4 described below.

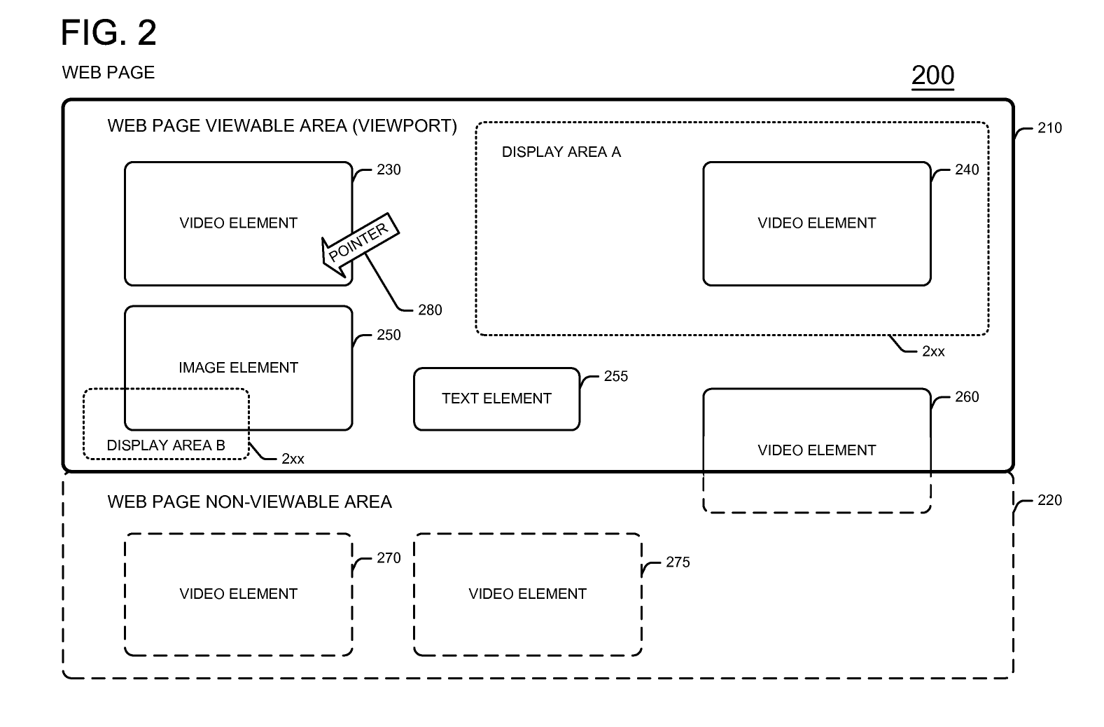

FIG. 2 is a representation of a web page 200. Web page 200 includes web page content such as web page 200 elements. Web page 200 may reside in memory, such as system memory 125 of IHS 100 that a designer or other entity configures with web content software according to the disclosed web content manager methodology. Web page 200 includes a web page viewable area 210 or viewport that includes those web page elements that a user may view on a display, such as display 135. Web page 200 also includes a web page non-viewable area 220 that may include web page elements that are not immediately viewable by a user on display 135. Web page non-viewable area 220 includes web page 200 elements that are outside the viewport of display 135 but are still part of web page 200 content. FIG. 2 uses dashed lines to illustrate web page non-viewable area 220. In one embodiment of the disclosed web content manager methodology, there may be other non-viewable portions of web page 200, and other web page 200 elements not shown.

Web page 200 includes a video element 230 within web page viewable area 210. Video element 230 may represent video stream data, or video content of any form for user viewing on display 135 as part of the content of web page 200. Web page 200 also includes an image element 250 within web page viewable area 210. Image element 250 represents an image, picture, diagram, clipart, or other image as part of web page 200 content. Web page 200 further includes a video element 240 within web page viewable area 210. Web page 200 also includes a text element 255 within web page viewable area 210. Text element 255 represents hypertext, or text in any other form, for viewing on display 135.

Web page 200 includes a video element 260 that partially resides within web page viewable area 210 and partially within web page non-viewable area 220. In other words, video element 260 is partially viewable by users of display 135 in the current position of the viewport. Portions of video element 260 are off the screen, or off display 135 or out of the viewport and non-viewable as part of web page non-viewable area 220. A user or other entity may scroll down, or otherwise modify the viewable portion of web page 200 to include all of, or other portions of, video element 260 in the viewport.

Web page 200 includes a video element 270 and a video element 275 as part of the web page non-viewable area 220. In one embodiment of the disclosed web content manager methodology, video element 230, video element 240, image element 250, text element 255, video element 260, video element 270, and video element 275 represent all web page content or web page elements of web page 200. Web page viewable area 210 includes a pointer or cursor 280. Pointer 280 may represent a mouse pointer that a user moves within the web page viewable area 210 of web page 200. In other embodiments of the disclosed web content manager methodology, pointer 280 may represent a pressure sensitive finger or stylus position, eye tracking technology, or any other pointing method usable within web page viewable area 210. In one embodiment of the disclosed web content manager methodology, pointer 280 may exist within web page non-viewable area 220 and thus not be viewable on display 135 without user intervention to move pointer 280 into viewable area 210.

As shown in FIG. 2, pointer 280 points at video element 230. This pointing may indicate to web content manager 180 that a particular user has a higher interest in video element 230 than other web elements of web page 200. Web content manager 180 may use this information to adjust priorities for web content rendering on display 135 and bandwidth allocation for video element 230 communications. Video element 230 communications may include communication bandwidth from the web source, as described in more detail below. Pointing devices may provide web content manager 180 with useful prioritization information that users may include in web page attributes 300. A user or other entity may define a region of web page viewable area 210 as a particular display area. For example, web page 200 includes a display area A and a display area B, as shown by dotted lines within web page viewable area 210. A user may identify an area of interest and place a higher priority on rendering web page 200 elements within display area A, display area B, or other user designated areas of web page viewable area 210 not shown.

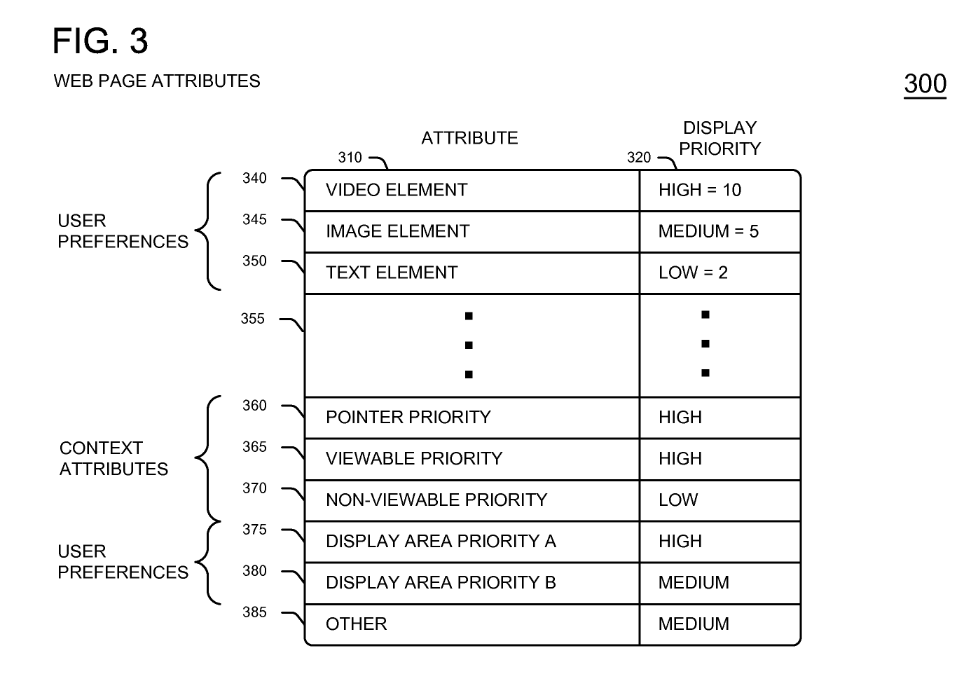

FIG. 3 is a representation of web page attributes 300. Web page attributes 300 show one example of web page information or attributes that web content manager 180 may generate and manage. In one embodiment of the disclosed web content manager methodology, web page attributes 300 include user modifiable attributes or information. A user, or other entity, using web content manager 180 may modify or otherwise populate web page attributes 300 with generic or user specific web page attribute information. These web page attributes may improve the user experience during web page 200 retrieval and rendering. Web content manager 180 may use the web page attributes 300 information to modify web page 200 content retrieval priorities. As used here, the term “retrieval” means acquiring web page content from a web server or other source for rendering on display 135. Web content manager 180 may also use the information of web page attributes 300 to adjust communication bandwidth, as well as prioritization of web page 200 elements during rendering on display 135 or other viewable resources.

Web page attributes 300 include a column 310 that shows particular web page 200 attribute elements as well as other web page 200 display content, such as pointers or other information. Column 320 shows the display priority that web content manager 180 assigns to each of web page attributes 300. In one embodiment of the disclosed web content manager methodology, the display priority, shown as high, medium, or low determines the relative importance of each web page 200 element during retrieval and rendering on display 135. In other embodiments of the disclosed web content manager methodology, the display priority may take on any weighted method, such as numerical weighting or other method to determine relative importance for each web page 200 attribute to the user during display 135 viewing. Web page attributes 300 include web page element attributes for each web page 200 element.

Web page attributes 300, row 340, column 310, show a representative attribute entry for any particular video element of web page 200. As shown in row 340, column 320, the video element attribute display priority is high. In one embodiment of the disclosed web content manager methodology, a high priority for a video element is equal to a numerical value or priority weighting of 10. This priority weighting of 10 represents one example of a numerical weighting method for determining the relative importance of one type of web page 200 element with respect to another type of web page 200 element. For example, this priority weighting may determine the relative importance of video element 230 with respect to another type of web page 200 element, such as image element 250, during retrieval and rendering of web page 200 by IHS 100. The video element attribute information in row 340, the image element attribute information in row 345, and the text element attribute information in row 350, are each examples of user web page preference information or user preference input categories for web page 200 content rendering prioritization. Input categories for web page 200 content rendering prioritization are described in more detail below in reference to Table 1.

Web page attributes 300, row 345, column 310, show a representative attribute entry for any particular image element of web page 200. As shown in row 345, column 320, the image element display priority is medium. In one embodiment of the disclosed web content manager methodology, a medium priority for an image element is equal to a numerical value of 5. This display priority of 5 demonstrates one example of a numerical weighting method to determine the relative importance of one type of web page 200 element, such as image element 250, with respect to another type of web page 200 element, such as text element 255, during retrieval and rendering of web page 200 by IHS 100.

Web page attributes 300, row 350, column 310, show a representative attribute entry for any particular text element of web page 200. As shown in row 350, column 320, the text element display priority is low. In one embodiment of the disclosed web content manager methodology, a low priority for a text element is equal to a numerical value of 2. This display priority of 2 demonstrates one example of a numerical weighting method for determining the relative importance of one type of web page 200 element, such as text element 255, with respect to another type of web page 200 element, such as video element 230, during retrieval and rendering of web page 200 by IHS 100. Web page attributes 300 includes web page element attributes and initial display priority data in rows 340 through 350 and columns 310 and 320.

As shown by the dotted line in steps column 355, web page attributes 300 may include other web page attributes and display priorities for other web page elements (not shown) of web page 200. The attributes of row 340, row 345, and row 350, namely video element, image element, and text element, respectively, all correspond to a particular input category for web page 200 content rendering priority. As described in more detail below, the video element attribute information, the image element attribute information, and the text element attribute information as shown in web page attributes 300 all correspond to a “user preferences” input category for web page prioritization rendering information.

In row 360, column 310, web page attributes 300 include a pointer 280 priority attribute. The pointer 280 priority attribute includes a corresponding display priority equal to “high” as shown in row 360, column 320. In one embodiment of the disclosed web content manager methodology, this high priority represents the relative priority of bandwidth allocation for those web page 200 elements that web content manager 180 determines to be within “near proximity” to that of pointer 280. In one embodiment of the disclosed web content manager methodology, web content manager 180 defines near proximity as in contact with pointer 280 or within a particular pixel count of pointer 280 on display 135.

In other embodiments, web content manager 180 may define near proximity by other methods. Any particular web page 200 element that is in near proximity to pointer 280 corresponds to a high display priority web page 200 element. Web content manager 180 may override the display priority for any web page 200 in near proximity to pointer 280. In other embodiments, web content manager 180 may enhance or otherwise increase the display priority for any particular web page 200 element in near proximity to pointer 280. In that manner, web content manager 180 overrides any display priority that web content manager 180 assigns previously to that particular web page 200 element.

In row 365, column 310, web page attributes 300 show a representative viewable priority attribute. The viewable attribute display priority shown in row 365, column 320, is high. In one embodiment of the disclosed web content manager methodology, web content manager 180 determines those web page 200 elements, such as video element 230, video element 240, image element 250, text element 255, and video element 260 of web page 200 that render within the web page viewable area 210.

Users or other entities may determine that web page 200 elements of web page 200 that render within the web page viewable area 210 may all exhibit a higher display priority than those web page 200 elements that render in the web page non-viewable area 220 of web page 200. In that manner, web content manager 180 modifies the display priority of all web page 200 elements within web page viewable area 210 to a higher display priority. For example, web content manager 180 may increase the display priority of video element 230 over that of video element 270. Web page 200 elements may render within web page viewable area 210 or within web page non-viewable area 220. However, only those web page 200 elements that render within web page viewable area 210 are visible to users on display 135 at any point in time. Web page 200 elements that render in web page non-viewable area 220 may consume IHS resources, such as communication bandwidth, that may be useful for other purposes.

Web content manager 180 may use any numerical weighting method that provides allocation of more communication bandwidth capability to the rendering of video element 230 than that of video element 270. In that manner, web page 200 elements outside the viewport of display 135 may exhibit a decrease in display priority. That display priority may determine the priority or weighting of communication bandwidth allocation for any particular web page 200 element as described in more detail below. IHS 100 provides communication bandwidth for web page 200 element rendering. IHS 100 may exhibit an Internet connection with greater communication bandwidth than that of web page 200 rendering communication capability. In one embodiment of the disclosed web content manager methodology, the communication bandwidth that IHS 100 employs to render web page 200 content may be a portion of the total communication bandwidth available from IHS 100 Internet communications capability.

Web page attributes 300, row 370, column 310, show a non-viewable display priority attribute. The non-viewable attribute display priority shown in row 370, column 320, is low. In one embodiment of the disclosed web content manager methodology, web content manager 180 determines those web elements, such as video element 270 and video element 275 of web page 200 as rendering outside the web page viewable area 210 as a low priority. These web page 200 elements that render in web page non-viewable area 220 represent a lower priority to users and therefore may require a lower display priority and corresponding bandwidth communication allocation. In one embodiment of the disclosed web content manager methodology, web content manager 180 may modify the display priority of all web page 200 elements within the web page non-viewable area 210 to a lower priority. For example, web content manager 180 may decrease the priority of video element 270 over that of video element 230. Web content manager 180 may use any numerical weighting method that provides allocation of less communication bandwidth resource to the rendering of video element 270 than that of video element 230.

In row 375, column 310, web page attributes 300 show a representative display area priority “A” attribute. The particular display area priority A attribute display priority shown in row 375, column 320, is high. In row 380, column 310, web page attributes 300 show a representative display area priority “B” attribute. The particular display area priority B attribute display priority shown in row 380, column 320, is low. In one embodiment of the disclosed web content manager methodology, web content manager 180 determines those web elements, such as video element 240 that render within proximity to display area A, as having a high priority. Web content manager 180 determines those web elements, such as image element 250 of web page 200 that render within proximity to display area B, as having a low priority. For example, a user or other entity may define a display area A that exhibits a higher priority for web page 200 element display than a display area B. The pointer priority attribute in row 360, the viewable priority attribute in row 365, and the non-viewable priority attribute in row 370 are each examples of context attributes information or context attribute category inputs for web page 200 content rendering prioritization, as described below in Table 1.

By using user inputs, web content manager 180, may increase the priority of video element 240 that resides in or in near proximity to display area A and decrease the priority of image element 250 that resides in or in near proximity to display area B. Other display area attributes and priorities that may include portions of web page viewable area 210, and portions of web page non-viewable area 220, are possible as alternative embodiments of the disclosed web content manager methodology. The display area priority A attribute in row 375 and the display area priority B attribute in row 380 are each examples of user preferences or user preference category inputs for web page 200 content rendering prioritization as described below in Table 1.

Web page attributes 300 may include still other attributes that a user or web content manager 180 may employ to provide prioritization of web page 200 content during rendering on display 135 or other viewable resources. As shown in row 385, column 310, an “other” attribute may exhibit a display priority of medium as shown in row 385, column 320, or any other priority not shown. In another embodiment of the disclosed web content manager methodology, web page attributes 300 may exhibit web page 200 specific attribute priority information. For example, a user may populate a portion of web page attributes 300 not shown, with particular web page prioritization information for that user's home page, or any other particular web page. Web content manager 180 may use this particular attribute display priority information when rendering the user home page.

Web page attributes 300 includes attributes that each represent an input category of web page 200 information. In other words, web page 200 may include content that corresponds to a particular input category for web page 200 content rendering prioritization, as shown below in Table 1. T 1 includes a column of categories of input for web page 200 content rendering prioritization. Table 1 depicts a column of examples of these web page 200 content inputs.

TABLE 1

| Input categories for | |
|---|---|
| web page 200 content | |
| rendering prioritization | Examples of web page 200 content input |
| Resource attributes | Screen position, fixed size, etc. |
| Context attributes | Viewport size, viewport position, pointer position, |
| | etc. |
| User preferences | Web page element priorities, display area |
| | priorities, etc. |
| Prioritization rules | Numerical weighting method for web page |
| | elements and category input sources. |

The categories of input for web page 200 content rendering prioritization include “resource attributes” as shown in row 1 of Table 1, “context attributes” in row 2 of Table 1, “user preferences” as shown in row 3 of Table 1, and “prioritization rules” in row 4 of Table 1 above.

Resource attributes may include screen position of each web page element, fixed size, such as number of pixels in length and width on display 135, and other resource attributes. Context attributes may include viewport size, viewport position, pointer 280 position, and other context attributes. User preferences may include web page 200 element priorities, display area priorities and other user preferences. Prioritization rules may include numerical weighting methodologies for each web page 200 element and sources for each of the other input categories for web page 200 content rendering prioritization information. Prioritization rules may provide web content manager 180 with a methodology and/or directives to determine bandwidth allocation for each web page 200 element.

Resource attributes are those attributes of web page attributes 300 that may exhibit fixed characteristics, such as HTML characteristics as part of web page 200 content. In one embodiment of the disclosed web content manager methodology, for each web page 200 element, such as a particular video element, resource attributes may include the screen position for that particular video element. For example, video element 230 may exhibit a fixed position, or screen position within web page viewable area 210. This screen position is one example of a resource attribute. Video element 230 may also exhibit a fixed size in pixels for display within web page viewable area 210 and thereby exhibit yet another resource attribute.

Context attributes are typically those attributes that correspond to the particular environment, such as display 135 characteristics, and the current state of web page 200. For example, those web page 200 elements within web page viewable area 210 may require different consideration for bandwidth allocation than those web page 200 elements within web page non-viewable area 220. Users or other entities may generate pointer 280 positioning and display area priorities, such as display area priority A and display area priority B context attributes. User preferences may include web page 200 display priority information as shown in web page attributes 300 row 340, row 345, and row 350 of FIG. 3.

Table 1 includes prioritization rules as a category of input for web page 200 content rendering prioritization. Web content manager 180 generates web page 200 element bandwidth allocation using these prioritization rules. Users may adjust or otherwise modify prioritization rules at any time during execution of bandwidth allocation resources. Other embodiments of the disclosed web content manager methodology may employ different categories of input for web page 200 content rendering prioritization.

In one embodiment of the disclosed web content manager methodology, web content manager 180 may determine the relative bandwidth weighting for each web page 200 element by weighting the display priority information as shown in column 320 as it pertains to each element. For example, if a total communication bandwidth is available for web page 200 retrieval of 100 kilobytes per second (kB/sec), web content manager 180 may allocate a portion of this 100 kB/sec bandwidth to each web page 200 element, such as video element 230, video element 240, image element 250, text element 255, video element 260, video element 270 and video element 275 of web page 200. This communication bandwidth allocation, may be a function of the respective display priorities of web page attributes 300, or other attributes not shown in Table 1. Web content manager 180 may determine bandwidth allocation on a per web page 200 element basis, such as for video element 230, video element 240, image element 250, text element 255, video element 260, video element 270 and video element 275 of web page 200.

Web browser 195 loads or retrieves web page 200 from an external source, such as remote server, or web server (not shown). Web content manager 180 may determine prioritization for each web page 200 element on the fly or during retrieval for each web page 200 element. Web content manager 180 may use the display priority information in web page attributes 300 to generate relative bandwidth allocation data for each web page 200 element, namely video element 230, video element 240, image element 250, text element 255, video element 260, video element 270 and video element 275. Web content manager 180 may generate relative bandwidth allocation for each web page 200 element prior to and during rendering on display 135.

The web page 200 source, such as a remote server (not shown), may communicate web page 200 content to IHS 100 through expansion bus 165, network interface adapter 170, or any other communication bus or method. In other embodiments of the disclosed web content manager methodology, the bandwidth scaling of high, medium, low may take on any weighted method, such as numerical weighting or other mechanism to determine relative communication allocation priority for each web page attribute 300 entry. Table 2 below represents one method that web content manager 180 provides bandwidth allocation for each web page 200 element.

TABLE 2

| | Prioritization bandwidth allocation (Steps) | | | | | | |
|---|---|---|---|---|---|---|---|
| Web page | 1 | | | | | | 7 |
| 200 elements | (initial) | 2 | 3 | 4 | 5 | 6 | (final) |
| Video element 230 | 10 | 50 | 100 | 100 | 100 | 100 | 50 |
| Video element 240 | 10 | 10 | 20 | 20 | 40 | 40 | 20 |
| Image element 250 | 5 | 5 | 10 | 10 | 10 | 28 | 14 |
| Text element 255 | 2 | 2 | 4 | 4 | 4 | 4 | 2 |
| Video element 260 | 10 | 10 | 20 | 20 | 20 | 20 | 10 |
| Video element 270 | 10 | 10 | 10 | 4 | 4 | 4 | 2 |
| Video element 275 | 10 | 10 | 10 | 4 | 4 | 4 | 2 |

Table 2 above shows one example of priority bandwidth allocation information that web content manager 180 provides for web page 200 elements, such as video element 230, video element 240, image element 250, text element 255, video element 260, video element 270 and video element 275. Table 2 depicts each web page 200 element in the first column. Table 2 shows successive steps, namely steps 1 through 7, that web content manager 180 employs to generate an ultimate or final communication bandwidth allocation as shown in step 7. Each priority bandwidth allocation (step) column of Table 2 depicts a respective display priority distribution by web content manager 180. The numerical priority examples given in Table 2 are for purposes of illustration. It should be understood that these numerical priority examples are representative and may vary in actual practice.

Step 1 represents “initial prioritizations” for video element 230, video element 240, image element 250, text element 255, video element 260, video element 270 and video element 275. Web content manager 180 refines or adjusts the initialization prioritization from step 1 to step 6 by applying a different context attribute or user preference for each step. Step 7 shows the final bandwidth prioritization that effectively is a normalization of the prioritization of step 6.

Web content manager 180 applies the pointer priority 360 of FIG. 3 to the initial prioritizations of step 1 to determine the interim prioritizations of step 2 of Table 2. This interim display prioritization is a modified display prioritization or a modification of the initial prioritization of step 1. Web content manager 180 next applies the viewable priority 365 of FIG. 3 to the interim prioritizations of step 2 to determine the interim prioritizations of step 3 of Table 2. Continuing from left to right in Table 2, web content manager 180 applies the non-viewable priority 370 of FIG. 3 to the interim prioritizations of step 3 to determine the interim prioritizations of step 4 of Table 2. Web content manager 180 applies the display priority A 375 of FIG. 3 to the interim prioritizations of step 4 to determine the interim prioritizations of step 5 of Table 2. Web content manager 180 then applies the display priority B 380 of FIG. 3 to the interim prioritizations of step 5 to determine the interim prioritizations of step 6 of Table 2. After performing the prioritization modifications of steps 2-6, web content manager 180 normalizes the display prioritizations of step 6 to generate the final or ultimate bandwidth allocation or prioritization of step 7. The following discussion describes steps 1-7 in much more detail.

In one embodiment of the disclosed web content manager methodology, web content manager 180 analyzes each web page 200 element, namely video element 230, video element 240, image element 250, text element 255, video element 260, video element 270 and video element 275 and allocates a priority consistent with the display priority information shown in FIG. 3, web page attributes 300, namely column 320. Table 2 shows a priority or steps 1 column that depicts the prioritization bandwidth allocation for each web page 200 element. For example, video element 230 exhibits a priority of 10 that corresponds to the high display priority as shown in web page attributes 300 row 340, column 320. Video element 240 exhibits a priority of 10 that corresponds to the high display priority as shown in web page attributes 300 row 340, column 320.

Continuing down the steps 1 column, image element 250 exhibits a priority of 5 that corresponds to the medium display priority as shown in web page attributes 300 row 345, column 320. Text element 255 exhibits a priority of 2 that corresponds to the low display priority as shown in web page attributes 300 row 350, column 320. Video elements 260, 270 and 275 each exhibit a priority of 10 that corresponds to the high display priority as shown in web page attributes 300 row 340, column 320. In one embodiment of the disclosed web content manager methodology, web content manager 180 continues to generate web page 200 prioritization by using inputs of other attributes as shown in web page attributes 300. Steps column 2 of Table 2 above is the next enhancement or modification of fine tuning for the development of prioritization bandwidth allocation by web content manager 180.

As shown by Table 2 above, web content manager 180 generates priority bandwidth allocation for web page 200 elements, namely video element 230, video element 240, image element 250, text element 255, video element 260, video element 270 and video element 275. In one embodiment of the disclosed web content manager methodology, web content manager 180 analyzes each web page 200 element, namely video element 230, video element 240, image element 250, text element 255, video element 260, video element 270 and video element 275 and adjusts or otherwise modifies each priority consistent with the pointer priority attribute information as shown in FIG. 3, web page attributes 300 row 360. Table 2 shows a steps 2 column that depicts the interim prioritization bandwidth allocation that web content manager 180 generates for each web page 200 element. For example, as shown in web page 200 of FIG. 2, pointer 280 points in the direction or proximity of video element 230. Web content manager 180 may examine the web page 200 elements of web page 200 and determine which web page 200 elements are in near proximity or in direct contact with pointer 280.

In this example, web content manager 180 determines that video element 230 is in contact with pointer 280. Web content manager 180 adjusts the priority of video element 230 in a numerical manner to provide a greater priority to the rendering of video element 230 on display 135, and more specifically to the communication bandwidth of the retrieval of video element 230 information from a remote web server. In one embodiment of the disclosed web content manager methodology, web content manager 180 increases the priority of video element 230 by 5 times to a priority of 50 as shown in Table 2 above, and more particularly in steps column 2 for video element 230. For each of the other web page 200 elements as shown in Table 2 above, web content manager 180 may determine that priorities for these web page 200 elements do not change since they are not in direct proximity to pointer 280.

Each of the other web page 200 elements, namely video element 240, image element 250, text element 255, video element 260, video element 270 and video element 275 maintain the same priority as shown in steps column 1. Image element 250 exhibits a priority of 5, and text element 255 exhibits a priority of 2. Video element 260 exhibits a priority of 10, and video element 270 exhibits a priority of 10. Video element 275 exhibits a priority of 10 or no change from the priority as shown in steps column 1 interim priority information.

Table 2 shows a prioritization bandwidth allocation steps column 3 that web content manager 180 determines or modifies by considering viewable priority information of web page attributes 300. In one embodiment of the disclosed web content manager methodology, web content manager 180 analyzes each web page 200 element, namely video element 230, video element 240, image element 250, text element 255, video element 260, video element 270 and video element 275 and adjusts or otherwise modifies each priority consistent with the viewable priority attribute information shown in FIG. 3, web page attributes 300 row 365. Table 2 shows a steps 3 column that depicts the prioritization bandwidth allocation that web content manager 180 provides for each web page 200 element. For example, as shown in web page 200 of FIG. 2, the viewable priority attribute of web page attributes 300 row 365 corresponds to web page viewable area 210. Web content manager 180 may examine the web page 200 elements of web page 200 and determine which particular web page elements reside completely within or primarily within web page viewable area 210.

In this example, web content manager 180 determines that video element 230 is within web page viewable area 210. In response to this determination, web content manager 180 adjusts the priority of video element 230 in a numerical manner to provide a greater priority to the rendering of video element 230 on display 135, and more specifically to the communication bandwidth of the retrieval of video element 230 information from a remote web server. In one embodiment of the disclosed web content manager methodology, web content manager 180 increases the priority of video element 230 by 2 times to a priority of 100 as shown in Table 2 above, and more particularly in steps column 3 for video element 230. Web content manager 180 determines that video element 240 is also within web page viewable area 210. Web content manager 180 adjusts the priority of video element 240 in a numerical manner to provide a greater priority to the rendering of video element 240 on display 135, and more specifically to the communication bandwidth of the retrieval of video element 240 information from a web server. In one embodiment of the disclosed web content manager methodology, web content manager 180 increases the priority of video element 240 by 2 times to a priority of 20 as shown in Table 2 above, in steps column 3 for video element 240.

Web content manager 180 determines that image element 250 is within web page viewable area 210. Web content manager 180 adjusts the priority of image element 250 in a numerical manner to provide a greater priority to the rendering of image element 250 on display 135, and more specifically to the communication bandwidth of the retrieval of image element 250 information from a web server or other source. In one embodiment of the disclosed web content manager methodology, web content manager 180 increases the priority of image element 250 by 2 times to a priority of 10 as shown in Table 2 above, in steps column 3 for image element 250.

Web content manager 180 further determines that text element 255 is within web page viewable area 210. Web content manager 180 adjusts the priority of text element 255 in a numerical manner to provide a greater priority to the rendering of text element 255 on display 135, and more specifically to the communication bandwidth of the retrieval of text element 255 information from a web server. In one embodiment of the disclosed web content manager methodology, web content manager 180 increases the priority of text element 255 by 2 times to a priority of 4 as shown in Table 2 above, steps column 3 for text element 255.

Web content manager 180 determines that video element 260 is primarily within web page viewable area 210. In one embodiment of the disclosed web content manager methodology, web content manager 180 may determine that video element 260 has either a portion or a majority portion of visibility within web page viewable area 210. In response to this determination, web content manager 180 adjusts the priority of video element 260 in a numerical manner to provide a greater priority to the rendering of video element 260 on display 135, and more specifically to the communication bandwidth of the retrieval of video element 260 information. In one embodiment of the disclosed web content manager methodology, web content manager 180 increases the priority of video element 260 by 2 times to a priority of 20 as shown in Table 2 above, steps 3 column for video element 260.

For each of the other web page 200 elements as shown in Table 2 above, namely video element 270, and video element 275, web content manager 180 may determine that priorities for these web page 200 elements do not change since they are not primarily visible within web page viewable area 210. Video element 270 exhibits a priority of 10, and video element 275 exhibits a priority of 10 corresponding to the same priority information as shown in steps column 2 for video element 270 and video element 275 in Table 2 above.

Web content manager 180 analyzes each web page 200 element, namely video element 230, video element 240, image element 250, text element 255, video element 260, video element 270 and video element 275 and adjusts or otherwise modifies each priority consistent with the non-viewable priority attribute information as shown in FIG. 3, web page attributes 300 row 370. Table 2 demonstrates a steps 4 column that depicts the interim prioritization bandwidth allocation that web content manager 180 generates for each web page 200 element. For example, as shown in web page 200 of FIG. 2, the non-viewable priority attribute may correspond to web page non-viewable area 220. Web content manager 180 may examine the web page 200 elements of web page 200 and determine which web page 200 elements reside completely within or primarily within web page non-viewable area 210. In response, web content manager 180 may determine that those web page 200 elements within web page non-viewable area 210 require a reduction in priority or priority penalty.

In this example, web content manager 180 determines that video element 230 is within web page viewable area 210 and requires no priority adjustment. Video element 230 maintains a priority bandwidth allocation of 100 as shown in Table 2 above, steps column 4 for video element 230. Web content manager 180 determines that video element 240 is within web page viewable area 210, and requires no priority adjustment. Video element 240 maintains a priority bandwidth allocation of 20 as shown in Table 2 above, steps column 4 for video element 240. In a similar manner web content manager 180 determines that image element 250, text element 255, and video element 260 are primarily within web page viewable area 210, and requires no priority adjustment for each. Image element 250, text element 255, and video element 260 maintain their respective priority bandwidth allocations of 10, 4, and 20 as shown in Table 2 above, steps column 4 for image element 250, text element 255, and video element 260, respectively.

Web content manager 180 does however determine that video element 270 is within web page non-viewable area 220. In response, web content manager 180 adjusts the priority of video element 270 in a numerical manner to provide a priority reduction or penalty toward the communication bandwidth of the retrieval of video element 270 information from a web server. In one embodiment of the disclosed web content manager methodology, web content manager 180 decreases the priority of video element 270 to a priority of 4 as shown in Table 2 above, steps column 4 for video element 270. In a similar manner, web content manager 180 determines that video element 275 is within web page non-viewable area 220. Web content manager 180 adjusts the priority of video element 275 in a numerical manner to provide a priority reduction or penalty toward the communication bandwidth of the retrieval of video element 275 information. In one embodiment of the disclosed web content manager methodology, web content manager 180 decreases the priority of video element 275 to a priority of 4 as shown in Table 2 above, steps column 4, for video element 275.

In one embodiment of the disclosed web content manager methodology, web content manager 180 analyzes each web page 200 element, namely video element 230, video element 240, image element 250, text element 255, video element 260, video element 270 and video element 275 and adjusts or otherwise modifies each priority consistent with the display area priority “A” attribute information, as shown in FIG. 3, web page attributes 300 row 375. Table 2 shows a steps column 5 information that depicts the prioritization bandwidth allocation that web content manager 180 modifies or generates for each web page 200 element. For example, as shown in web page 200 of FIG. 2, display area A corresponds to a location within web page viewable area 210 that is near or in proximity to video element 240. Web content manager 180 may examine the web page 200 elements of web page 200 and determine which particular web page 200 elements are in proximity to display area A of web page viewable area 210. In the example of FIG. 2, video element 240 is near or in proximity to display area A.

In one embodiment of the disclosed web content manager methodology, web content manager 180 determines that video element 230 is not in proximity to display area A and does not adjust the priority of video element 230. Video element 230 maintains a prioritization bandwidth allocation of 100 as shown in Table 2 above, steps column 5 for video element 230. Web content manager 180 does however determine that video element 240 is in proximity to display area A. Web content manager 180 adjusts the priority of video element 240 in a numerical manner to provide a greater priority to the rendering of video element 240 on display 135, and more specifically to the communication bandwidth for retrieval of video element 240 information. In one embodiment of the disclosed web content manager methodology, web content manager 180 increases the priority of video element 240 by 2 times to a priority of 40 as shown in Table 2 above steps column 5 for video element 240.

For each of the other web page 200 elements shown in Table 2 above, namely image element 250, text element 255, video element 260, video element 270, and video element 275, web content manager 180 may determine that priorities for these web page 200 elements do not change since they are not in proximity to display area A in web page viewable area 210. Image element 250 exhibits a priority of 10 and text element 255 exhibits a priority of 4 in steps column 5, corresponding to the same priority information shown in steps column 4 for each of image element 250 and text element 255 in Table 2 above. Video element 260 exhibits a priority of 20 and video element 270 exhibits a priority of 4 in steps column 5, corresponding to the same priority information shown in steps column 4 for each of video element 260 and video element 270 in Table 2 above. Video element 275 exhibits a priority of 4 in steps column 5, corresponding to the same priority information shown in steps column 4 for video element 275 in Table 2 above.

Web content manager 180 adjusts or otherwise modifies each web page 200 element priority consistent with the display area priority “B” attribute information as shown in FIG. 3, web page attributes 300 row 380. Table 2 shows a steps column 6 information that depicts the prioritization bandwidth allocation that web content manager 180 generates for each web page 200 element. For example, as shown in web page 200 of FIG. 2, display area B corresponds to a location within web page viewable area 210 that is near or in proximity to image element 250. Web content manager 180 may examine the web page 200 elements of web page 200 and determine which web page 200 elements are in proximity to display area B of web page viewable area 210. Image element 250 is near or in proximity to display area B.

In one embodiment of the disclosed web content manager methodology, web content manager 180 determines that video element 230, and video element 240 are not in near proximity to display area B and does not adjust the priority priorities of video element 230 or video the priority of video element 240. Video element 230 and video element 240 maintain a prioritization bandwidth allocation of 100 and 40, respectively, as shown in Table 2 above, steps column 6. Web content manager 180 does however determine that image element 250 is in near proximity to display area B. In response to this determination, web content manager 180 adjusts the priority of image element 250 in a numerical manner to provide a greater priority to the rendering of image element 250 on display 135, and more specifically to the communication bandwidth for retrieval of image element 250 information. In one embodiment of the disclosed web content manager methodology, web content manager 180 increases the priority of image element 250 from 10 to 28 as shown in Table 2 above, steps column 6 for image element 250.

For each of the other web page 200 elements as shown in Table 2 above, namely text element 255, video element 260, video element 270, and video element 275, web content manager 180 may determine that priorities for these web page 200 elements do not change since they are not in near proximity to display area B. In steps column 6, text element 255 and video element 260 exhibit a priority of 4 and a priority of 20, respectively, corresponding to the same priority information shown in steps column 5 for text element 255 and video element 260. In steps column 6, video element 270 and video element 275 each exhibit a priority of 4 corresponding to the same priority information shown in steps column 5 for each of video element 270 and video element 275.

Web content manager 180 determines prioritization bandwidth allocation information as shown in successive priority steps column 1 through steps column 6 data of Table 2 above. In one embodiment of the disclosed web content manager methodology, web content manager 180 generates the ultimate or final prioritization bandwidth allocation, as shown in the data of steps column 6 of Table 2 above. However, in order to generate true communication bandwidth allocation, web content manager 180 may perform a normalization step as shown in steps column 7 in Table 2 above. For example, the total communication bandwidth for web page 200 retrieval may be equal to 100 kB/sec in one example. Web content manager 180 normalizes each web page 200 element priority consistent with the total communication bandwidth of 100 kB/sec. The summation of all web page 200 element priorities, as shown in steps column 6 is equal to 200, for example 100+40+28+4+20+4+4=200. Web content manager 180 may perform a normalization step to divide each web page 200 priority of steps column 6 by a normalization divisor. In this particular example, the normalization divisor is 2, namely the summation, 200, divided by the total bandwidth 100. Of course, other examples would have other normalization divisors depending on the particular application.

Web content manager 180 determines and controls the ultimate or final prioritization bandwidth allocation for video element 230. Web content manager 180 divides the priority information as shown in steps column 6 of Table 2 above for video element 230 by the normalization divisor of 2. In other words, the ultimate or final bandwidth allocation for video element 230 equals 100 divided by 2 or 50 kB/sec, as shown in steps column 7 of Table 2 above for video element 230. Web content manager 180 determines the ultimate or final prioritization bandwidth allocation for video element 240. Web content manager 180 divides the priority as shown in steps column 6 of Table 2 above for video element 240 by the normalization divisor of 2. In other words, the ultimate or final bandwidth allocation for video element 240 equals 40 divided by 2 or 20 kB/sec, as shown in steps column 7 of Table 2 above for video element 240.

Web content manager 180 also determines the ultimate or final prioritization bandwidth allocation for image element 250. Web content manager 180 divides the priority information as shown in steps column 6 of Table 2 above for image element 250 by the normalization divisor of 2. In other words, the ultimate or final bandwidth allocation for image element 250 equals 28 divided by 2 or 14 kB/sec, as shown in steps column 7 of Table 2 above for image element 250. Web content manager 180 determines the ultimate or final prioritization bandwidth allocation for text element 255. Web content manager 180 divides the priority as shown in steps column 6 of Table 2 above for text element 255 by the normalization divisor of 2. In other words, the ultimate or final bandwidth allocation for text element 255 equals 4 divided by 2 or 2 kB/sec, as shown in steps column 7 of Table 2 above for text element 255.

Web content manager 180 determines the ultimate or final prioritization bandwidth allocation for video element 260. Web content manager 180 divides the priority information as shown in steps column 6 of Table 2 above for video element 260 by the normalization divisor of 2. In other words, the ultimate or final bandwidth allocation for video element 260 equals 20 divided by 2 or 10 kB/sec, as shown in steps column 7 of Table 2 above for video element 260. Web content manager 180 determines the ultimate or final prioritization bandwidth allocation for video element 270. Web content manager 180 divides the priority as shown in steps column 6 of Table 2 above for video element 270 by the normalization divisor of 2. In other words, the ultimate or final bandwidth allocation for video element 270 equals 4 divided by 2 or 2 kB/sec, as shown in steps column 7 of Table 2 above for video element 270.

Web content manager 180 determines the ultimate or final prioritization bandwidth allocation for video element 275. Web content manager 180 divides the priority as shown in steps column 6 of Table 2 above for video element 275 by the normalization divisor of 2. In other words, the ultimate or final bandwidth allocation for video element 275 equals 4 divided by 2 or 2 kB/sec, as shown in steps column 7 of Table 2 above for video element 275. In this manner, web content manager 180 determines bandwidth allocation for each web page 200 element of web page 200 and the ultimate or final bandwidth allocation results are shown in steps column 7 of Table 2 above. During retrieval and rendering of web page 200, IHS 100 determines the communication bandwidth for each web page 200 element consistent with the ultimate or final bandwidth allocation as shown in steps column 7 of Table 2 above. Bandwidth allocation, as shown in step 7 of Table 2, stays in place during rendering of web page 200 until user interactions modify web page 200 content, web page attributes 300, or other viewing factors. For example, if video element 230 includes video streaming information, the bandwidth allocation for video element 230 remains intact during subsequent renderings of new content for video element 230 to display 135.

Steps column 1 of Table 2 shows one form of initial display priority for each web page 200 element. Steps columns 2 through 6 show one form of modified or interim display priority information for web page 200 elements. Steps column 7 represents one form of the ultimate or final bandwidth allocation for each web page 200 element. One embodiment of the disclosed web content manager methodology, provides a method wherein web content manager 180 generates prioritization bandwidth allocation information for each web page 200 element in successive priority steps, namely step 1 through step 7, as shown in Table 2 above. Other embodiments of the web page 200 element priority generation are possible that may include different web page 200 attribute data, other content rendering prioritization inputs instead of, or in addition to, those of Table 1 above, or other numerical priority weighting methods.

In one embodiment of the disclosed web content manager methodology, web page 200 may include embedded web page attributes 300 information along with web page 200 element information. For example, a particular web page may include initial display priority information as shown in web page attributes, FIG. 3 column 320, for a particular web page element or other display priority data. Web page 200, for example, may include a display priority of high for video element 230 or other web page element as part of initial web page 200 content. Web content manager 180 may populate web page attributes 300 with this initial priority bandwidth allocation information from web page 200 as shown in the initial step 1 of Table 2 above.

The flowchart of FIG. 4 illustrates the architecture, functionality, and operation of possible implementations of systems, methods and computer program products that perform web page content management in accordance with various embodiments of the present invention. In this regard, each block in the flowchart of FIG. 4 may represent a module, segment, or portion of code, which comprises one or more executable instructions for implementing the specified logical function(s). It should also be noted that, in some alternative implementations, the functions noted in the block may occur out of the order noted in FIG. 4. For example, two blocks shown in succession may, in fact, be executed substantially concurrently, or the blocks may sometimes be executed in the reverse order, depending upon the functionality involved. It will also be noted that each block of FIG. 4 and combinations of blocks in the block diagrams and/or flowchart illustration, can be implemented by special purpose hardware-based systems that perform the specified functions or acts, or combinations of special purpose hardware and computer instructions.

FIG. 4 is a flowchart that shows process flow in an embodiment of the disclosed methodology that provides user selectable attribute control during web page 200 content retrieval and rendering. More specifically, the flowchart of FIG. 4 shows how the embedded web content manager 180 of FIG. 1 determines a bandwidth allocation for each web page 200 element from user and other input criteria that web content manager 180 maintains in web page attributes 300. The disclosed web content manager method starts, as per block 405. In one embodiment, a user provides or inputs web page 200 user preference information, as per block 410. As shown in Table 1 above, a user may provide user specific user preference information for store into web page attributes 300. For example, user preference information may include web page 200 element priorities as shown in web page attributes 300 row 340, row 345, and row 350 for video element, image element and text element display priority information, respectively. User preference information may include display area priorities, as shown in web page attributes 300 row 375 and row 380, for display area priority A and display area priority B display priority information, respectively.

Web content manager 180 with user input generates web page context attribute information, as per block 415. For example web content manager 180 may interrogate pointer 280 position, web page viewable area 210 as well as other information as shown in Table 1 above to generate web page attributes 300 context attribute information. Web page attributes 300 may include information from previous web page 200 retrievals or default information as set forth by web content manager 180 during initialization of web browser 195. Web browser 195 loads web page 200 content into memory for next display, as per block 420. For example IHS 100 executes web browser 195 to retrieve web page 200 from a remote source, such as a remote server (not shown). Web browser 195 loads web page 200 content into system memory 125 for the next display on display 135.

During web page 200 retrieval web content manager 180 generates web page 200 resource attributes, as per block 425. Web content manager 180 generates web page 200 resource attributes as shown in Table 1 above. For example, web content manager 180 may determine that video element 230 exhibits a particular screen position, such as the upper left-hand portion of web page 200 viewable area 210. This information is specific to the web page 200 contents and as such, web content manager 180 treats this information as resource attributes that apply typically to each web page 200 element during retrieval. In one embodiment of the disclosed web content manager methodology, web content manager 180 analyzes HTML information during retrieval of web page 200 to determine resource attribute information.

Web content manager 180 determines web page 200 element prioritization using prioritization rules as shown in Table 1, as per block 430. Prioritization rules is one category of input for web page 200 content rendering prioritization. As demonstrated above in the discussion of Table 2, web content manager 180 performs successive priority generation steps to determine the ultimate or final priority for each web page 200 element. In one embodiment of the disclosed web content manager methodology, web content manager 180 performs successive priority generation steps, such as those described and shown in steps column 1 through steps column 6 in Table 2 above.

Web content manager 180 normalizes web page 200 element prioritization data and determines bandwidth allocation, as per block 435. In other words, web content manager 180 determines the total bandwidth capacity for communications from a remote server (not shown), or other web page 200 source into IHS 100, such as through expansion bus 165, network interface adapter 170, or other communication source. In one embodiment of the disclosed web content manager methodology, the total communication bandwidth for web page 200 retrieval is 100 kB/sec. Web content manager 180 normalizes the priority information as shown in steps column 6 of Table 2 above to fit within the total bandwidth of 100 kB/sec. For example, web content manager 180 may determine that a normalization divisor equal to 2 will provide a normalization of web page 200 priority information. As shown in steps column 7 Table 2 above, web content manager 180 determines an ultimate or final prioritization bandwidth allocation for each web page 200 element.

Web content manager 180 retrieves and renders web page 200 elements to display 135 using bandwidth allocation, as per block 440. In other words, web content manager 180 uses the bandwidth allocation for each web page 200 element, as described and shown above in steps column 7 of Table 2 during retrieval and rendering of web page 200. In this manner, web content manager 180 interprets and determines user preferences for web page 200 content during rendering onto display 135. The disclosed web content manager methodology ends, as per block 460. In an alternative embodiment, web content manager may apply one priority with respect to retrieving a particular element from a web server and another priority with respect to rendering or displaying that particular element on a display. In other words, IHS 100 may apply different resources toward retrieval of web page 200 elements and to that of rendering web page 200 elements on display 135.

As will be appreciated by one skilled in the art, aspects of the disclosed memory management technology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of managing web content, comprising:
receiving, by a web content manager, user web page preference information including web page attributes that include web page element attributes, each web page element attribute exhibiting a respective initial display priority;
receiving, by the web content manager, context attributes information that specifies characteristics of a particular display environment;
receiving, by the web content manager, a particular web page of information from a web source, the particular web page including particular web page elements;
determining, by the web content manager, web page resource attributes corresponding to the particular web page;
determining, by the web content manager, an initial display priority for each of the particular web page elements;
determining, by the web content manager, a modified display priority for each of the particular web page elements by applying at least one of user preferences information and context attributes information to the particular web page elements;
assigning, by the web content manager, a bandwidth allocation for each particular web page element based on the modified display priority for each of the particular web page elements; and
displaying, by the web content manager, each particular web page element based on the modified display priority for each particular web page element.

2. The method of claim 1, further comprising:
storing, by the web content manager, default web page attributes without user input.

3. The method of claim 1, further comprising:
storing, by the web content manager, web page attributes specific to a particular web page for subsequent use.

4. The method of claim 1, wherein the web page attributes include prioritization rules.

5. The method of claim 1, further comprising normalizing, by the web content manager, the modified display priorities of the particular web page elements of the particular web page.

6. The method of claim 1, wherein web page elements include two or more of video elements, image elements and text elements.

7. The method of claim 1, wherein the web content manager applies a higher modified display priority to web page elements that are within a display viewport than to those web page elements that are not within the display viewport.

8. An information handling system (IHS), comprising:
a processor;
a memory, coupled to the processor, that includes a web content manager that is configured to:
receive user web page preference information including web page attributes that include web page element attributes, each web page element attribute exhibiting a respective initial display priority;
receive context attributes information that specifies characteristics of a particular display environment;
receive a particular web page of information from a web source, the particular web page including particular web page elements;
determine web page resource attributes corresponding to the particular web page;
determine an initial display priority for each of the particular web page elements;
determine a modified display priority for each of the particular web page elements by applying at least one of user preferences information and context attributes information to the particular web page elements;
assign a bandwidth allocation for each particular web page element based on the modified display priority for each of the particular web page elements; and
display each particular web page element based on the modified display priority for each particular web page element.

9. The IHS of claim 8, wherein the web content manager is further configured to store default web page attributes without user input.

10. The IHS of claim 8, wherein the web content manager is further configured to store web page attributes specific to a particular web page for subsequent use.

11. The IHS of claim 8, wherein the web page attributes include prioritization rules.

12. The IHS of claim 8, wherein the web content manager is further configured to normalize the modified display priorities of the particular web page elements of the particular web page.

13. The IHS of claim 8, wherein web page elements include two or more of video elements, image elements and text elements.

14. The IHS of claim 8, wherein the web content manager applies a higher modified display priority to web page elements that are within a display viewport than to those web page elements that are not within the display viewport.

15. A web content manager computer program product, comprising:
a computer readable storage medium for use on an information handling system (IHS);
first instructions that receive user web page preference information including web page attributes that include web page element attributes, each web page element attribute exhibiting a respective initial display priority;
second instructions that receive context attributes information that specifies characteristics of a particular display environment;
third instructions that receive a particular web page of information from a web source, the particular web page including particular web page elements;
fourth instructions that determine web page resource attributes corresponding to the particular web page;
fifth instructions that determine an initial display priority for each of the particular web page elements;
sixth instructions that determine a modified display priority for each of the particular web page elements by applying at least one of user preferences information and context attributes information to the particular web page elements;
seventh instructions that assign a bandwidth allocation for each particular web page element based on the modified display priority for each of the particular web page elements; and
eighth instructions that display each particular web page element based on the modified display priority for each particular web page element;
wherein the first, second, third, fourth, fifth, sixth, seventh and eighth instructions are stored on the computer readable storage medium.

16. The web content manager computer program product of claim 15, further comprising ninth instructions that store default web page attributes without user input.

17. The web content manager computer program product of claim 15, further comprising tenth instructions that store web page attributes specific to a particular web page for subsequent use.

18. The web content manager computer program product of claim 15, wherein the web page attributes include prioritization rules.

19. The web content manager computer program product of claim 15 further comprising eleventh instructions that normalize the modified display priorities of the particular web page elements of the particular web page.

20. The web content manager computer program product of claim 15, wherein web page elements include two or more of video elements, image elements and text elements.

21. The web content manager computer program product of claim 15, further comprising twelfth instructions that apply a higher modified display priority to web page elements that are within a display viewport than to those web page elements that are not within the display viewport.
